(19) United States
(12) Patent Application Publication
(10) Pub. No.: US 2018/0359235 A1
(43) Pub. Date: Dec. 13, 2018

(54) TRANSMISSION APPARATUS AND COMMUNICATION METHOD

(71) Applicant: FUJITSU LIMITED, Kawasaki-shi (JP)

(72) Inventors: Yoshinari Akakura, Oyabe (JP); Takanori Sasaki, Takaoka (JP); TAKUYA MAEDA, Kanazawa (JP); Tadayuki Nishihashi, Kanazawa (JP)

(73) Assignee: FUJITSU LIMITED, Kawasaki-shi (JP)

(21) Appl. No.: 16/001,779

(22) Filed: Jun. 6, 2018

(30) Foreign Application Priority Data
Jun. 13, 2017 (JP) 2017-116154

(51) Int. Cl. H04L 29/06; H04Q 11/00; H04L 9/32; H04L 9/08

(52) U.S. Cl. CPC H04L 63/08; H04Q 11/0067; H04Q 2011/0079; H04L 9/0819; H04L 9/32

(57) ABSTRACT

A transmission apparatus includes a memory, and a processor coupled to the memory and configured to process communication performed via logical-links established between the transmission apparatus and ONUs coupled to branch ends of a transmission line, perform, for each of the logical-links, a setting process for the communication for the ONUs, acquire, after the setting process, processing-information relating to processing of the communication from the ONUs for each of the logical-links, and store the processing-information in a database, acquire, in accordance with timings at which the logical-links have been re-established after disconnection, processing-information of the logical-links from the ONUs, and make a comparison of the processing-information with the processing-information stored in the database, and omit, in accordance with a result of the comparison, part of the setting process for the logical-links for which the processing-information acquired from the ONUs coincide with the processing-information stored in the database.

### CROSS-REFERENCE TO RELATED APPLICATION

This application is based upon and claims the benefit of priority of the prior Japanese Patent Application No. 2017-116154, filed on Jun. 13, 2017, the entire contents of which are incorporated herein by reference.

### FIELD

The embodiment discussed herein is related to a transmission apparatus and a communication method.

### BACKGROUND

As a subscriber optical access system that provides an optical communication service to a subscriber's home, such as an apartment or office, a passive optical network (PON) system is used (for example, Japanese Laid-open Patent Publication Nos. 2011-130250 and 2012-124687). The PON system includes an optical line terminal (OLT) installed in a station building of an optical communication service provider, and an optical network unit (ONU) installed in, for example, a subscriber's home. An example of the PON system is a system specified in the Institute of Electrical and Electronics Engineers (IEEE) 802.3ah.

The OLT is connected to a plurality of ONUs (for example, 64 ONUs) via a transmission line composed of one optical fiber and a plurality of optical fibers into which the optical fiber is split by an optical splitter. Thus, the cost of optical fiber installation in the PON system is kept low in comparison with a point-to-point optical access system using a media converter or the like.

The OLT communicates with an ONU in units of logical links (LLs). Before the start of communication between the OLT and the ONU, an authentication sequence is executed in units of LLs to ensure the security of user data.

### SUMMARY

According to an aspect of the invention, a transmission apparatus includes a memory, and a processor coupled to the memory and the processor configured to process communication performed via logical links established between the transmission apparatus and a plurality of optical network units (ONUs) coupled to branch ends of a transmission line, and perform, for each of the logical links, a setting process for the communication for the plurality of ONUs, the processor being further configured to acquire, after the setting process, pieces of processing information relating to processing of the communication from the plurality of ONUs for each of the logical links, and store the pieces of processing information in a database, acquire, in accordance with timings at which the logical links have been re-established after disconnection, pieces of processing information of the logical links from the plurality of ONUs, and make a comparison of the pieces of processing information with the pieces of processing information stored in the database, and omit, in accordance with a result of the comparison, part of the setting process for the logical links for which the pieces of processing information acquired from the plurality of ONUs coincide with the pieces of processing information stored in the database.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram illustrating an example of a PON system;

FIG. 2 is a sequence diagram illustrating an example of a sequence process performed before the start of communication between an OLT and an ONU;

FIG. 3 is a configuration diagram illustrating an example of the OLT;

FIG. 4 illustrates an example of an ONU management database;

FIG. 5 illustrates an example of LL state transitions;

FIG. 6 illustrates an example of a statistical information table;

FIG. 7 is a sequence diagram illustrating an example of a normal authentication process (first);

FIG. 8 is a sequence diagram illustrating an example of the normal authentication process (second);

FIG. 9 is a sequence diagram illustrating an example of a simple authentication process;

FIG. 10 is a sequence diagram illustrating an example of a process of acquiring an LL state;

FIG. 11 is a sequence diagram illustrating an example of processes of acquiring specific information and an encryption key;

FIG. 12 is a sequence diagram illustrating an example of a process of storing hardware setting information;

FIG. 13 is a sequence diagram illustrating an example of a determination process of determining whether to execute the simple authentication process;

FIG. 14 is a flowchart illustrating an example of operations performed by a line unit on startup;

FIG. 15 is a flowchart illustrating an example of operations performed by the line unit when an authentication sequence is executed; and

FIG. 16 illustrates an example of times spent on the normal authentication process and the simple authentication process for each of the numbers of LLs.

### DESCRIPTION OF EMBODIMENT

An authentication sequence for ensuring the security of user data is usually executed when a new ONU is installed and is connected to an OLT. However, for example, on an OLT side, when an optical fiber is reconnected, or when replacement of line units and a restart of a line unit are performed, the authentication sequence is executed for each of LLs of each ONU, in sequence, to resume communication having been interrupted. In the authentication sequence, not only an ONU authentication process but also many setting processes related to, for example, multicast, a communication rate of an operation, administration, maintenance (OAM) frame, dynamic bandwidth allocation (DBA), and encryption are performed.

For this reason, in the case where communication having been interrupted due to an OLT-side factor, such as the above, is resumed, the later the authentication sequence is executed for an LL, the later the communication performed via the LL is resumed, and thus the fairness of communication service between LLs is reduced in accordance with the order of execution for LLs.

For example, Japanese Laid-open Patent Publication No. 2011-130250 discloses that an OLT determines, based on an initialization flag of an ONU, whether initialization of the ONU has been completed. Even with respect to an ONU for which it is determined that initialization has been completed, the time when the initialization has been completed is not known, and thus there is a possibility that latest setting may not have been performed for the ONU. Hence, initialization may have to be performed again to perform normal communication, and it is conceivable that resumption of communication will be delayed.

Furthermore, for example, Japanese Laid-open Patent Publication No. 2012-124687 discloses that a process, such as authentication, is executed in the order of priorities assigned to respective LLs. Priorities are fixed values, and thus it is conceivable that the process may be executed late for even an LL via which, for example, communication has to be quickly resumed in certain circumstances because the LL has a low priority.

An embodiment of a technique that enables quick resumption of communication will be described in detail below with reference to the drawings. A disclosed technique is not limited by the following embodiment.

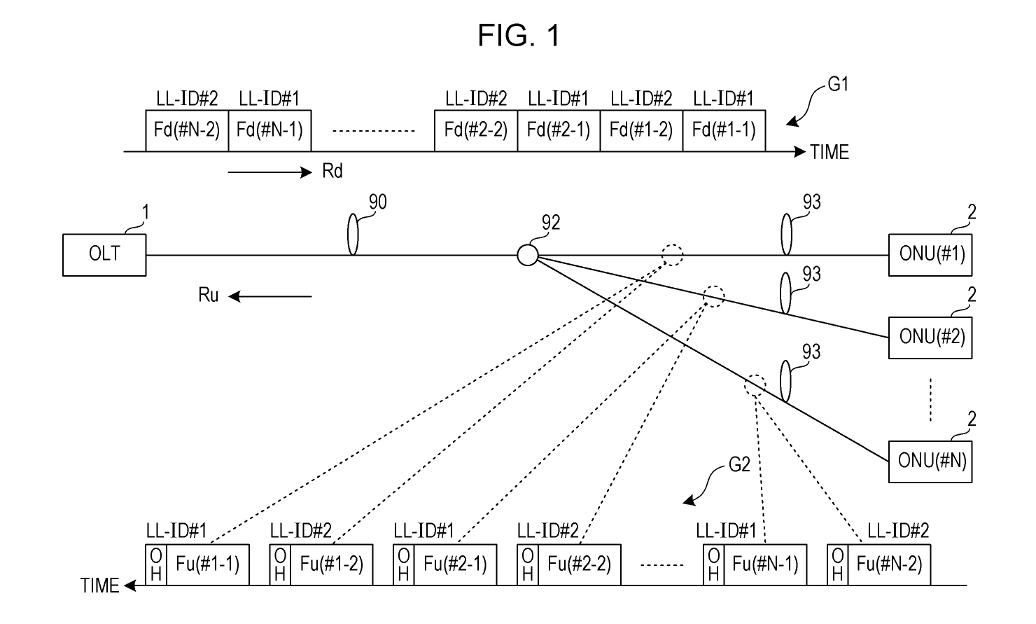

FIG. 1 is a configuration diagram illustrating an example of a PON system. The PON system includes an optical line terminal (OLT) 1 installed in a station building of an optical communication service provider, and an N number of optical network units (ONUs) 2 installed in, for example, subscriber's homes (N: an integer of two or more).

In this example, a transmission direction from the OLT 1 to the ONUs 2 is defined as a downstream direction Rd, and a transmission direction from the ONUs 2 to the OLT 1 is defined as an upstream direction Ru. The OLT 1 is an example of a communication apparatus. Furthermore, an example of the PON system in this example is a system specified in IEEE 802.3ah, however the PON system is not limited to this.

The OLT 1 is connected to an optical fiber 90, and the optical fiber 90 is connected to a plurality of optical fibers 93 via an optical splitter 92. Furthermore, the ONUs 2 are connected to the optical fibers 93. A transmission line of the PON system is composed of one optical fiber 90 and the plurality of optical fibers 93 into which the optical fiber 90 is split. That is, the ONUs (#1 to #N) 2 are connected to branch ends of the transmission line connected to the OLT 1.

Thus, the cost of optical fiber installation in the PON system is kept low in comparison with a point-to-point optical access system using a media converter or the like. Note that #1 to #N are ONU-IDs for identifying the respective ONUs 2.

The OLT 1 and each ONU 2 establish one or more logical links (LLs), and transmit and receive an upstream frame Fu and a downstream frame Fd to and from each other in units of LLs. For example, each ONU 2 establishes two LLs with the OLT 1. LLs are identified by respective LL-IDs.

In the PON system, the N number of ONUs 2 communicate with the OLT 1 via the common optical fiber 90. For this reason, in the downstream direction Rd, as indicated by sign G1, the OLT 1 transmits downstream frames Fd (#1-1 to #N-2) addressed to the ONUs 2 in a time-division multiplexing manner. A downstream frame Fd(#K-M) (where K=1, 2, . . . , N, and M=1, 2) denotes a downstream frame Fd of an LL-ID#M of an ONU(#K) 2. The order in which downstream frames Fd are aligned depends on statistical multiprocessing of downstream frames Fd addressed to the ONUs 2 in the OLT 1 and thus is not limited to this example.

Furthermore, since the transmission line composed of the optical fibers 90 and 93 is split, a downstream frame Fd is transmitted to all the ONUs 2 connected to the OLT 1. For this reason, when transmitting a downstream frame Fd, the OLT 1 encrypts the downstream frame Fd with an encryption key of each LL generated by an ONU 2. The ONU 2 periodically updates the encryption key in accordance with an update period set by the OLT 1.

On the other hand, in the upstream direction Ru, as indicated by sign G2, the ONUs 2 transmit, in a burst manner, upstream frames Fu (#1-1 to #N-2) at transmission timings individually specified in advance by the OLT 1, thereby avoiding a collision between the upstream frames Fu of the ONUs 2 in the common optical fiber 90. An upstream frame Fu(#K-M) denotes an upstream frame Fu of the LL-ID#M of the ONU(#K) 2.

The OLT 1 controls a bandwidth of an upstream frame Fu for each LL using DBA. The OLT 1 dynamically allocates a bandwidth to an ONU 2 for each LL in accordance with the amount of data of upstream frames Fu that are awaiting to be transmitted (that is, the amount of data accumulated in a queue) notified for each LL by the ONU 2. Thus, the ONU 2 transmits, to the OLT 1, an upstream frame or frames Fu corresponding to a transmission time period based on the allocated bandwidth. An example of the formats of an upstream frame Fu and a downstream frame Fd is an ETHERNET® frame, and the formats are not limited to this.

As just described, the OLT 1 communicates with the ONU 2 in units of LLs. Before the start of communication between the OLT 1 and the ONU 2, an authentication sequence is executed in units of LLs to ensure the security of user data.

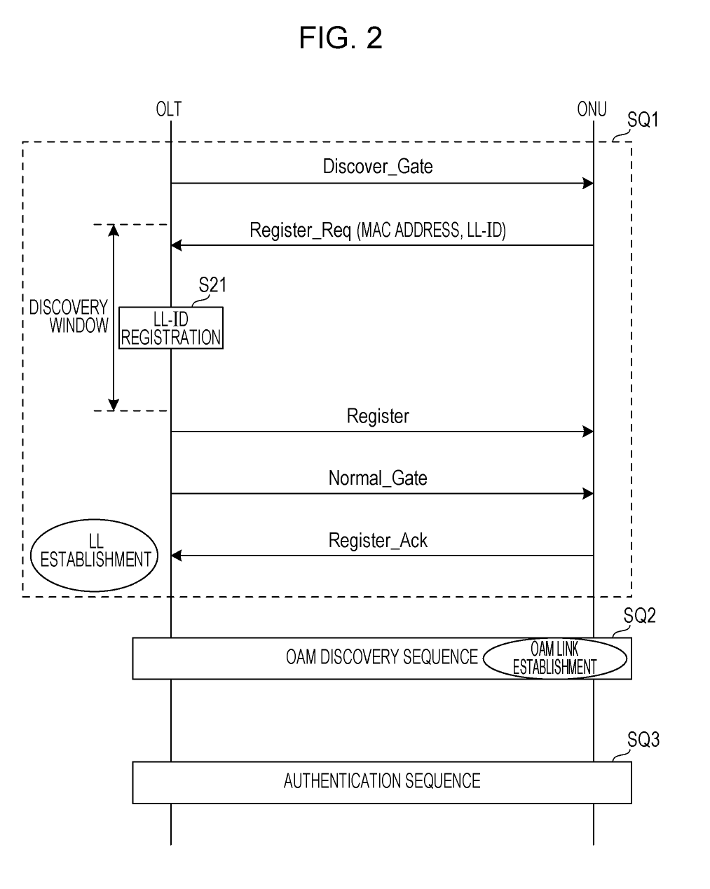

FIG. 2 is a sequence diagram illustrating an example of a sequence process performed before the start of communication between the OLT 1 and an ONU 2. A sequence in this example is executed by transmitting and receiving control frames based on multi-point control protocol (MPCP). The OLT 1 and the ONU 2 execute a link establishment sequence SQ1, an operation, administration, maintenance (OAM) discovery sequence SQ2, and an authentication sequence SQ3, in this order.

In the link establishment sequence SQ1, the OLT 1 transmits a Discover_Gate frame to the ONU 2. The Discover_Gate frame notifies the ONU 2 of a time and a duration of time at and during which a request for an authentication process for each LL of the ONU 2 is received, that is, a period. This period is called a discovery window, for example. The OLT 1 periodically transmits a Discover_Gate frame to periodically provide a discovery window on a time axis in preparation for installation of a new ONU 2.

To make a request for LL registration, the ONU 2 transmits a Register_Req frame to the OLT 1 at a time obtained by adding a random delay to the time of which the ONU 2 has been notified. The Register_Req frame arrives at the OLT 1 at a timing within the discovery window. The OLT 1 registers an LL-ID to be allocated to the ONU 2 (sign S21) and transmits a Register frame to the ONU 2 to notify the ONU 2 of the LL-ID. If the OLT 1 registers four LLs, the OLT 1 notifies the ONU 2 of LL-IDs #1 to #4.

Then, the OLT 1 transmits a Normal_Gate frame to the ONU 2 to notify the ONU 2 of a transmission start time and the amount of transmission data of an upstream frame Fu for each logical link. The ONU 2 transmits a Register_Ack message to the OLT 1 as a response to the Register frame. Thus, a logical link (LL) is established between the OLT 1 and the ONU 2.

Then, the OAM discovery sequence SQ2 is executed between the OLT 1 and the ONU 2. In the OAM discovery sequence SQ2, the OLT 1 and the ONU 2 transmit and receive OAM frames to and from each other, and thus an OAM-level link (hereinafter referred to as “OAM link”) is established between the OLT 1 and the ONU 2.

Then, the authentication sequence SQ3 is executed between the OLT 1 and the ONU 2. In the authentication sequence SQ3, the OLT 1 authenticates the ONU 2 for each LL based on a MAC address or an ONU-ID (hereinafter referred to as “identification information”) in response to an authentication request from the ONU 2.

The authentication sequence SQ3 is usually executed when a new ONU 2 is installed and is connected to the OLT 1. However, for example, on an OLT 1 side, when the optical fiber 90 is reconnected, or when replacement of line units and a restart of a line unit are performed, the authentication sequence SQ3 is executed for each LL of each ONU 2, in sequence, to resume communication having been interrupted. In the authentication sequence SQ3, not only an authentication process for the ONU 2 but also many setting processes related to, for example, multicast, a communication rate of an OAM frame, DBA, and encryption are performed.

For this reason, in the case where communication having been interrupted due to an OLT 1-side factor, such as the above, is resumed, the later the authentication sequence SQ3 is executed for an LL, the later the communication performed via the LL is resumed, and thus the fairness of communication service between LLs is reduced in accordance with the order of execution for LLs.

Thus, the OLT 1 acquires processing information relating to processing of communication with the ONU 2 for each LL and stores the processing information in a database. In accordance with a timing at which an LL has been re-established after disconnection, the OLT 1 acquires processing information of the LL from the ONU 2 and compares the processing information with the processing information stored in the database. Then, the OLT 1 omits part of the authentication sequence SQ3 for the LL for which the pieces of processing information coincide with each other as a result of the comparison.

Thus, as described below, the OLT 1 is able to appropriately omit part of the authentication sequence SQ3 for an LL based on a timing at which the LL has been re-established after disconnection and a comparison result of comparing pieces of processing information relating to processing of communication with the ONU 2.

In the case where there is a factor causing re-establishment of an LL on the OLT 1 side, the ONU 2 has already been started up, and thus a timing of re-establishment of the LL is earlier than that in the case where a factor causing re-establishment is an ONU 2-side factor (for example, a restart of the ONU 2). For this reason, the OLT 1 is able to detect, from the timing of re-establishment of the LL, that the OLT 1 has been restarted, or that the optical fiber 90 connecting the OLT 1 and the ONU 2 has been reconnected. Re-establishment of an LL due to an OLT 1-side factor is hereinafter referred to as “re-establishment due to OLT factor”.

When the OLT 1 determines, from a timing of re-establishment of an LL, that re-establishment due to OLT factor has been performed, the OLT 1 compares, for each LL, processing information having been stored in the database after the authentication sequence SQ3 executed before the re-establishment with processing information acquired after the re-establishment, and thus is able to select an LL for which part of the authentication sequence SQ3 is able to be omitted. Processing information relating to communication includes, for example, an encryption key to be described and differs according to communication settings of the OLT 1 and the ONU 2.

Hence, the OLT 1 is able to determine, by comparison of pieces of processing information with each other, whether latest communication setting has been performed for the ONU 2 immediately before re-establishment due to OLT factor, and thus is able to determine, for each LL, based on the determination, whether to omit part of the authentication sequence SQ3. For example, with respect to an ONU 2 having been restarted around the same time as re-establishment due to OLT factor, pieces of processing information of the ONU 2 do not coincide with each other, and thus it is determined that part of the authentication sequence SQ3 is not able to be omitted.

Hence, the OLT 1 appropriately omits part of the authentication sequence SQ3 for an LL to reduce a time spent on the authentication sequence SQ3 and thus is able to quickly resume communication with the ONU 2. A process of the authentication sequence SQ3 part of which is omitted and a process of the authentication sequence SQ3 that is normal (no part of which is omitted) are hereinafter referred to as “simple authentication process” and “normal authentication process”, respectively. The normal authentication process is an example of a setting process for communication for each LL.

On the other hand, for example, as in Japanese Laid-open Patent Publication No. 2011-130250 described above, suppose that an initialization flag is provided in the ONUs 2. Even with respect to an ONU 2 for which it is determined that initialization has been completed, the time when the initialization has been completed is not known, and thus there is a possibility that latest setting may not have been performed for the ONU 2. Hence, initialization may have to be performed again to perform normal communication, and resumption of communication may be delayed.

Furthermore, for example, as in Japanese Laid-open Patent Publication No. 2012-124687 described above, suppose that a process, such as authentication, is executed in the order of priorities assigned to respective LLs. Priorities are fixed values, and thus the process may be executed late for even an LL via which, for example, communication has to be quickly resumed in certain circumstances because the LL has a low priority.

Next, an example of the configuration of the OLT 1 will be described.

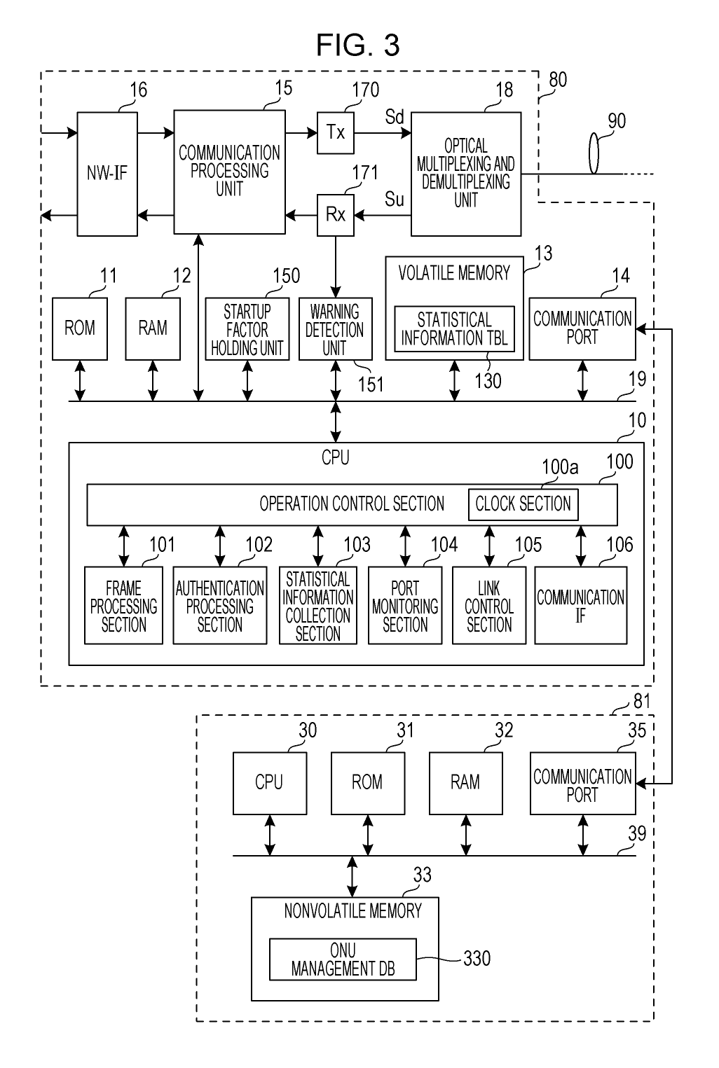

FIG. 3 is a configuration diagram illustrating an example of the OLT 1. The OLT 1 includes a line unit 80 that is an example of a transmission apparatus, and a monitoring control unit 81. The line unit 80 executes communication processing in a PON line, and the monitoring control unit 81 performs a monitoring control process on the line unit 80. A plurality of line units 80 may be installed.

The line unit 80 and the monitoring control unit 81 are each composed of, for example, a circuit board on which a plurality of optical components or electrical components are mounted, and are installed in slots provided in a housing of the OLT 1. The line unit 80 and the monitoring control unit 81 are connected via, for example, a wiring board and an electrical connector that are provided in the OLT 1, and exchange input and output data with each other via the wiring board.

The line unit 80 includes a communication processing unit 15, a warning detection unit 151, a startup factor holding unit 150, a network interface unit (NW-IF) 16, a transmitter (Tx) 170, a receiver (Rx) 171, and an optical multiplexing and demultiplexing unit 18. The communication processing unit 15, the warning detection unit 151, and the NW-IF 16 are each a circuit composed of hardware, such as a field programmable gate array (FPGA) or an application specific integrated circuit (ASIC), for example. The startup factor holding unit 150 is a circuit composed of hardware, such as a complex programmable logic device (CPLD), for example.

Furthermore, the line unit 80 includes a central processing unit (CPU) 10, a read only memory (ROM) 11, a random access memory (RAM) 12, a volatile memory 13, and a communication port 14. The CPU 10 is connected to the ROM 11, the RAM 12, the volatile memory 13, the communication port 14, the communication processing unit 15, the warning detection unit 151, and the startup factor holding unit 150 via a bus 19 so that the CPU 10 is able to exchange input and output signals with them.

The optical multiplexing and demultiplexing unit 18 is a wavelength division multiplexing (WDM) coupler, for example, and is connected to the optical fiber 90, the transmitter 170, and the receiver 171 via three ports. The optical multiplexing and demultiplexing unit 18 guides, to the optical fiber 90, an optical signal Sd in the downstream direction Rd input from the transmitter 170, and guides, to the receiver 171, an optical signal Su in the upstream direction Ru input from the optical fiber 90.

The receiver 171 is composed of a circuit including a photodiode (PD), for example, and converts the optical signal Su into an electrical signal to thereby acquire an upstream frame Fu from the optical signal Su. The receiver 171 identifies upstream frames Fu (#1 to #N) from the ONUs 2 based on transmission timings allocated to the ONUs 2. The receiver 171 outputs the upstream frame Fu to the communication processing unit 15. Furthermore, the receiver 171 outputs, to the warning detection unit 151, a detection signal indicating detection of light input from the optical fiber 90.

The warning detection unit 151 detects, from the detection signal, a warning indicating discontinuation of input of light to the OLT 1 (hereinafter referred to as “light input discontinuation warning”). A light input discontinuation warning is detected in accordance with, for example, removal or disconnection of the optical fiber 90. The warning detection unit 151 outputs the light input discontinuation warning to the CPU 10, and the CPU 10 determines, from the light input discontinuation warning, that a physical link of an optical port of the line unit 80 is in a disconnection state.

Furthermore, the transmitter 170 is composed of a circuit, such as a laser diode (LD) or a modulator, for example, and converts a downstream frame Fd input from the communication processing unit 15 into an optical signal to output the optical signal to the optical multiplexing and demultiplexing unit 18.

The communication processing unit 15 processes communication performed via an LL. The communication processing unit 15 outputs an OAM frame received from an ONU 2 to the CPU 10, and transmits an OAM frame input from the CPU 10 from the transmitter 170 to the ONU 2. In this way, the line unit 80 executes the above-described link establishment sequence SQ1, OAM discovery sequence SQ2, and authentication sequence SQ3.

In the upstream direction Ru, the communication processing unit 15 generates a data signal from an upstream frame Fu and outputs the data signal to the NW-IF 16. The communication processing unit 15 controls a bandwidth of an upstream frame Fu for each LL based on a bandwidth control setting relating to DBA (hereinafter referred to as “DBA setting”) from the CPU 10.

In the downstream direction Rd, the communication processing unit 15 generates a downstream frame Fd from a data signal input from the NW-IF 16 and outputs the downstream frame Fd to the transmitter 170. At this time, the communication processing unit 15 encrypts downstream frames Fd with encryption keys of respective LLs set by the CPU 10.

Furthermore, the communication processing unit 15 generates statistical information of an upstream frame Fu and a downstream frame Fd being received and transmitted from and to an ONU 2. More specifically, the communication processing unit 15 counts the number of upstream frames Fu received and the number of downstream frames Fd transmitted, for example. The communication processing unit 15 outputs the statistical information to the CPU 10, and the CPU 10 determines, based on the statistical information, normality of communication for each LL.

The NW-IF 16 converts a data signal input from the communication processing unit 15 into a format, for example, to transmit the converted data signal to an upstream network. Furthermore, the NW-IF 16 converts a data signal received from the upstream network into a format, for example, to output the converted data signal to the communication processing unit 15.

The startup factor holding unit 150 holds a register indicating the type of a reset that is a factor causing startup of the line unit 80 (hereinafter referred to as “startup factor register”). A startup factor register is set from, for example, the CPU 10 and a reset circuit, which is not illustrated, on startup of the line unit 80.

A startup factor register indicates a hardware reset in which the entire line unit 80 is reset, or a software reset in which only the CPU 10 is reset. In a determination process of determining whether re-establishment due to OLT factor has been performed, the CPU 10 reads the startup factor register from the startup factor holding unit 150.

The CPU 10 executes the link establishment sequence SQ1, the OAM discovery sequence SQ2, the authentication sequence SQ3, and communication processing for each LL in conjunction with the communication processing unit 15 using a function implemented by accessing the ROM 11.

The ROM 11 stores a program that drives the CPU 10. The RAM 12 functions as a working memory for the CPU 10. Furthermore, the volatile memory 13 stores a statistical information table (TBL) 130. The statistical information TBL 130 indicates statistical information generated by the communication processing unit 15. An example of the volatile memory 13 is a dynamic RAM (DRAM).

The communication port 14 processes communication with the monitoring control unit 81 over a local area network (LAN), for example.

The monitoring control unit 81 includes a CPU 30, a ROM 31, a RAM 32, a nonvolatile memory 33, and a communication port 35. The CPU 30 is connected to the ROM 31, the RAM 32, and the communication port 35 via a bus 39 so that the CPU 30 is able to exchange input and output signals with them.

The ROM 31 stores a program that drives the CPU 30. The RAM 32 functions as a working memory for the CPU 30. The communication port 35 processes communication with the line unit 80 over the LAN, for example.

The nonvolatile memory 33 stores an ONU management database (DB) 330 as an example of a database. An example of the nonvolatile memory 33 is a flash memory.

The CPU 30 controls access from the CPU 10 of the line unit 80 to the nonvolatile memory 33 via the communication ports 14 and 35. For this reason, the CPU 10 is able to perform writing to and reading from the ONU management DB 330.

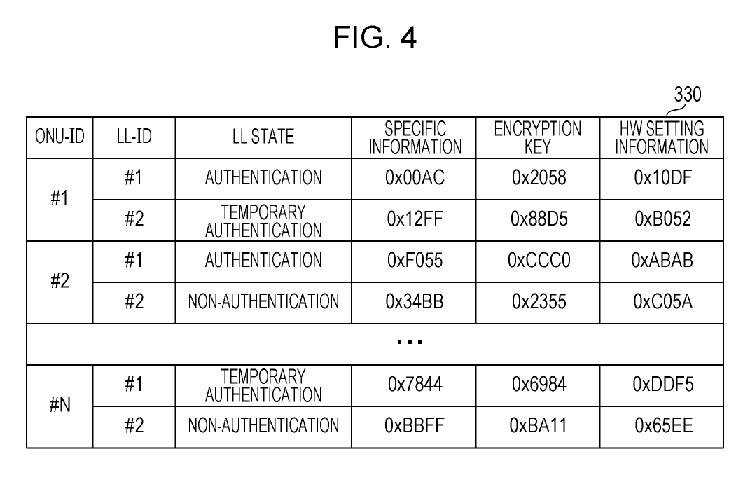

FIG. 4 illustrates an example of the ONU management DB 330. In the ONU management DB 330, information relating to an authentication process of each LL is registered.

More specifically, in the ONU management DB 330, an ONU-ID, an LL-ID, an LL state, specific information, an encryption key, and hardware (HW) setting information are registered in association with one another. An LL state is an example of state information relating to the state of the authentication sequence SQ3 of each LL and is managed by the CPU 10 of the line unit 80.

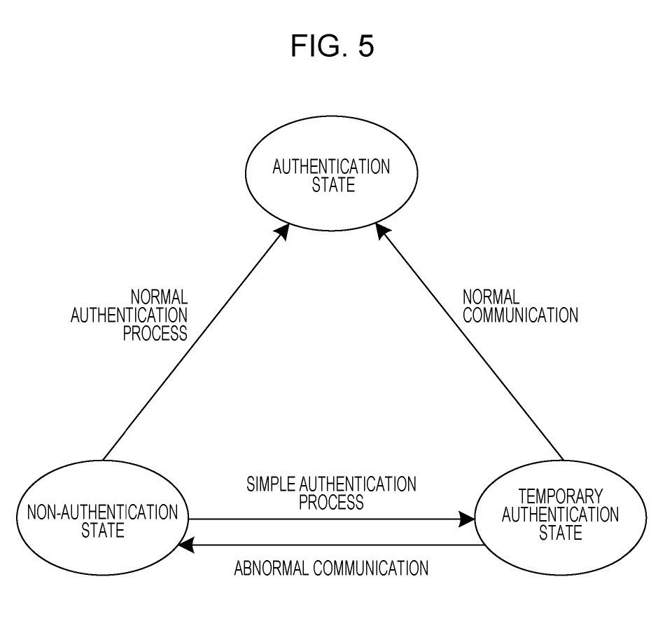

FIG. 5 illustrates an example of LL state transitions. The CPU 10 manages an LL state by dividing the LL state into a non-authentication state in which neither the normal authentication process nor the simple authentication process has been completed, a temporary authentication state in which the simple authentication process has been completed, and an authentication state in which the normal authentication process has been completed. In the case where the normal authentication process is performed for an LL being in the non-authentication state, the CPU 10 causes the LL state to transition to the authentication state. In the case where the simple authentication process is performed for an LL being in the non-authentication state, the CPU 10 causes the LL state to transition to the temporary authentication state.

Furthermore, the CPU 10 determines, based on statistical information of an LL being in the temporary authentication state, normality of communication. If communication is normal (see “normal communication”), the CPU 10 causes the LL state to transition to the authentication state. If communication is abnormal (see “abnormal communication”), the CPU 10 causes the LL state to transition to the non-authentication state. In this way, LL state transitions are performed.

Referring back to FIG. 4, the CPU 10 periodically stores an LL state in the ONU management DB 330. When re-establishment due to OLT factor is performed, the CPU 10 acquires an LL state immediately before the re-establishment from the ONU management DB 330 and uses the LL state in determining whether to execute the simple authentication process.

Furthermore, specific information is an example of processing information relating to processing of communication, and is information specific to each LL. As specific information, there is setting information of a queue and a layer-2 switch of each LL provided in an ONU 2, and the specific information is not limited to this. For example, the CPU 10 reads specific information from the ONU 2 after the normal authentication process has been completed, stores the specific information in the ONU management DB 330, and compares the specific information with specific information newly read from the ONU 2 after re-establishment due to OLT factor has been performed.

An encryption key is an example of processing information relating to processing of communication as described above. For example, the CPU 10 reads an encryption key from the ONU 2 during or after the normal authentication process, stores the encryption key in the ONU management DB 330, and compares the encryption key with an encryption key newly read from the ONU 2 after re-establishment due to OLT factor has been performed. Both when pieces of specific information coincide with each other and when encryption keys coincide with each other, the CPU 10 executes the simple authentication process. Otherwise, the CPU 10 executes the normal authentication process. However, conditions for executing the simple authentication process and the normal authentication process are not limited to these. Only when pieces of specific information coincide with each other, or only when encryption keys coincide with each other, the CPU 10 may execute the simple authentication process.

HW setting information is information set for the communication processing unit 15 by the CPU 10. An example of HW setting information is information relating to DBA or the like. Whenever the CPU 10 sets HW setting information for the communication processing unit 15, the CPU 10 stores the HW setting information in the ONU management DB 330. For example, in the case where the CPU 10 executes the simple authentication process, the CPU 10 sets the HW setting information stored in the ONU management DB 330 for the communication processing unit 15.

Referring back to FIG. 3, when the CPU 10 of the line unit 80 reads the program from the ROM 11, an operation control section 100, a frame processing section 101, an authentication processing section 102, a statistical information collection section 103, a port monitoring section 104, a link control section 105, and a communication interface section (communication IF) 106 are formed. The operation control section 100 is an operating system (OS), for example, and includes a clock section (system clock) 100a that provides a time. The operation control section 100 acquires, by using the clock section 100a, a time when the line unit 80 has been started up (hereinafter referred to as “startup time”).

The operation control section 100 instructs, in accordance with a sequence or a flowchart, which will be described later, the frame processing section 101, the authentication processing section 102, the statistical information collection section 103, the port monitoring section 104, the link control section 105, and the communication IF 106 to perform various operations.

The communication IF 106 is a communication driver for the communication processing unit 15. Thus, the operation control section 100, the frame processing section 101, the authentication processing section 102, the statistical information collection section 103, the port monitoring section 104, and the link control section 105 communicate with the communication processing unit 15 via the communication IF 106.

The frame processing section 101 generates various OAM frames in accordance with instructions provided by the operation control section 100 and outputs the various OAM frames to the operation control section 100. The operation control section 100 outputs an OAM frame to the communication processing unit 15 via the communication IF 106. The communication processing unit 15 transmits the OAM frame to an ONU 2 that is a destination of the OAM frame.

Furthermore, various OAM frames are input from the communication processing unit 15 to the frame processing section 101 via the communication IF 106. The frame processing section 101 outputs an OAM frame to the operation control section 100.

The statistical information collection section 103 is an example of a function processed by a processor and detects a communication amount of communication for each LL from the communication processing unit 15. More specifically, the statistical information collection section 103 periodically collects statistical information from the communication processing unit 15 and registers the statistical information in the statistical information TBL 130.

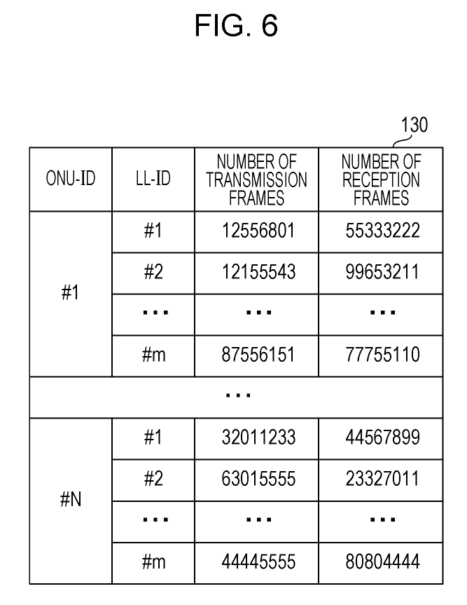

FIG. 6 illustrates an example of the statistical information TBL 130. The statistical information TBL 130 indicates statistical information of each LL.

In the statistical information TBL 130, an ONU-ID, an LL-ID, the number of transmission frames, and the number of reception frames are registered. The number of transmission frames is the number of downstream frames Fd transmitted from the communication processing unit 15 to an ONU 2, and the number of reception frames is the number of upstream frames Fu received by the communication processing unit 15 from the ONU 2.

Referring back to FIG. 3, the port monitoring section 104 monitors an optical port connected to an ONU 2 by accessing the warning detection unit 151. More specifically, a light input discontinuation warning is input to the port monitoring section 104 from the warning detection unit 151. The port monitoring section 104 acquires, from the clock section 100a, a time when the light input discontinuation warning has been removed, that is, a time when a physical link with each ONU 2 (hereinafter referred to as “physical link”) has been established (hereinafter referred to as “physical link time”), and outputs the physical link time to the operation control section 100.

The link control section 105 executes the link establishment sequence SQ1 with an ONU 2 to thereby establish an LL with the ONU 2, and further executes the OAM discovery sequence SQ2 with the ONU 2 to thereby establish an OAM link with the ONU 2. In the link establishment sequence SQ1 and the OAM discovery sequence SQ2, the link control section 105 transmits and receives control frames to and from the ONU 2.

The link control section 105 acquires, from the clock section 100a, a time when the OAM link has been established (hereinafter referred to as “OAM link time”), and outputs the OAM link time to the operation control section 100. The operation control section 100 notifies the authentication processing section 102 of the startup time, the physical link time, and the OAM link time in accordance with a request from the authentication processing section 102.

The authentication processing section 102 determines, from the startup time, the physical link time, and the OAM link time, whether re-establishment due to OLT factor has been performed. When a time difference between the startup time and the OAM link time is, for example, 10 minutes or less, the authentication processing section 102 determines that re-establishment due to OLT factor has been performed. Even if the time difference between the startup time and the OAM link time exceeds, for example, 10 minutes, when a time difference between the physical link time and the OAM link time is, for example, 10 minutes or less, the authentication processing section 102 determines that re-establishment due to OLT factor has been performed.

An OAM link is established after establishment of an LL, and an OAM link time is thus determined according to a time when the LL has been established. That is, the authentication processing section 102 determines, from a timing at which an LL has been re-established after disconnection, whether re-establishment due to OLT factor has been performed. In the determination, the authentication processing section 102 may use a time of re-establishment of an LL in place of an OAM link time.

Furthermore, to more accurately determine that re-establishment due to OLT factor has been performed, the authentication processing section 102 may determine whether an LL state is the authentication state, as described below. When the authentication processing section 102 determines that re-establishment due to OLT factor has been performed, the authentication processing section 102 appropriately omits part of the authentication sequence SQ3 for the corresponding LL based on a comparison result of comparing pieces of processing information relating to processing of communication with the corresponding ONU 2.

After establishment of an OAM link, the authentication processing section 102 executes the authentication sequence SQ3. The authentication processing section 102 is an example of a function processed by a processor. In the authentication sequence SQ3, the authentication processing section 102 performs, for each LL, a setting process for communication for each ONU 2 and the communication processing unit 15.

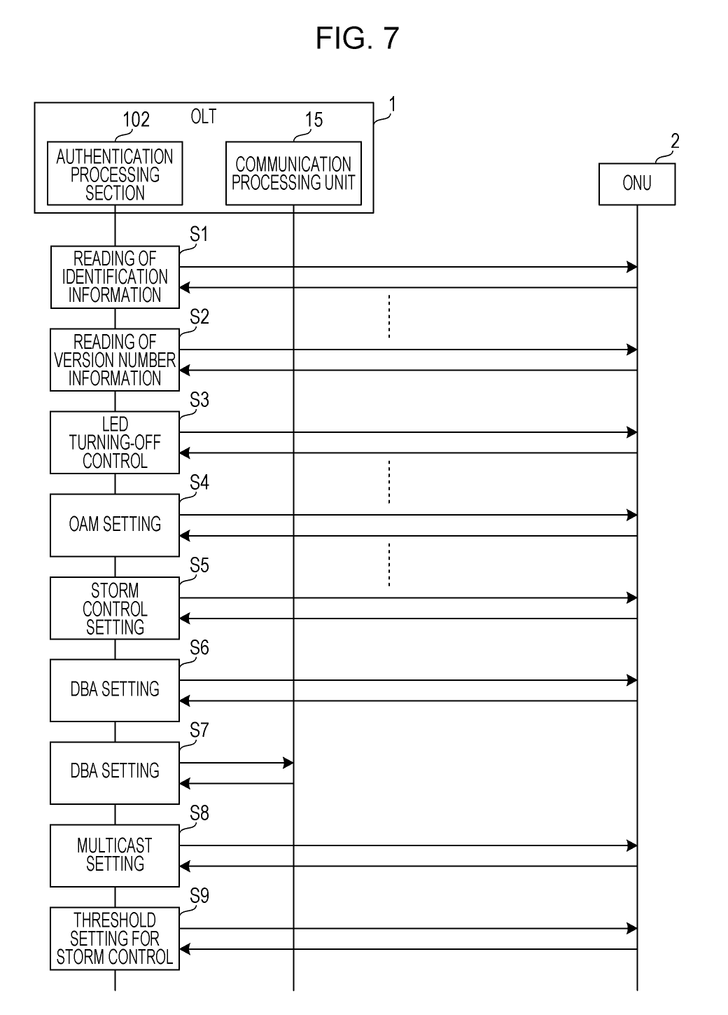

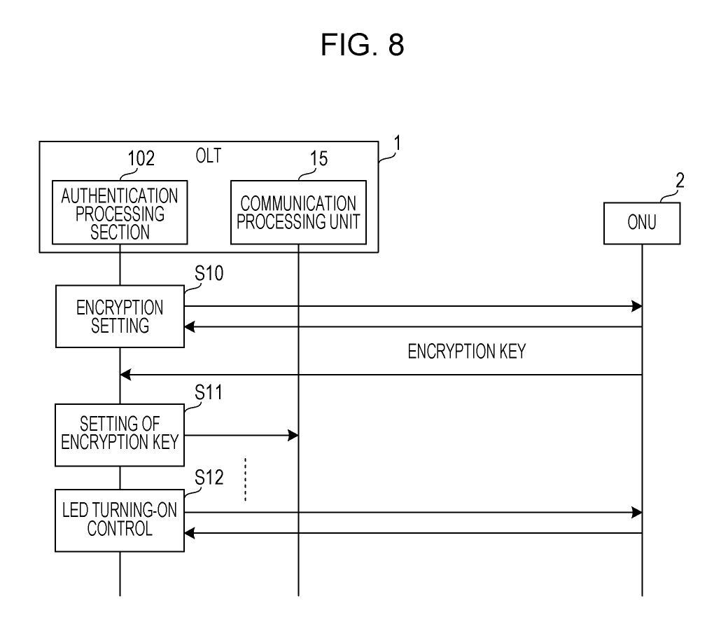

FIGS. 7 and 8 are sequence diagrams illustrating an example of the normal authentication process. The authentication processing section 102 executes a sequence of FIG. 7 and then executes a sequence of FIG. 8.

In the present sequence, the authentication processing section 102 transmits and receives OAM frames to and from an ONU 2. At this time, the operation control section 100 instructs the frame processing section 101 to generate an OAM frame in response to a request from the authentication processing section 102, and then an OAM frame is generated and transmitted. Furthermore, when an OAM frame is input to the frame processing section 101 from the ONU 2 via the communication processing unit 15, the frame processing section 101 transfers the OAM frame to the operation control section 100, and the operation control section 100 outputs the OAM frame to the authentication processing section 102.

The authentication processing section 102 reads identification information (ONU-ID, MAC address) from the ONU 2 (sign S1), and then reads version number information of the ONU 2 from the ONU 2 (sign S2). Identification information and version number information are used in a determination process of determining whether to perform authentication. Then, the authentication processing section 102 controls turning off of a light-emitting diode (LED) of the ONU 2 (sign S3).

Then, the authentication processing section 102 performs OAM setting for the ONU 2 (sign S4). In OAM setting, a rate of an OAM frame is set, for example. Then, the authentication processing section 102 performs storm control setting for the ONU 2 (sign S5). Storm control is a function of keeping the load on a network from increasing due to a mistake in the setting of and an abnormality in the network, for example. An OAM setting and a storm control setting are respective settings common to LLs of each ONU 2.

Then, the authentication processing section 102 performs DBA setting for the ONU 2 (sign S6), and then performs DBA setting for the communication processing unit 15 (sign S7). Then, the authentication processing section 102 performs multicast setting for the ONU 2 (sign S8). Multicast is a function of transmitting common data to a plurality of ONUs 2 in streaming broadcast, for example. Then, the authentication processing section 102 performs threshold setting for storm control for the ONU 2 (sign S9).

Next, the authentication processing section 102 performs encryption setting for the ONU 2 (sign S10). At this time, the ONU 2 generates an encryption key with which the OLT 1 encrypts a downstream frame Fd, and transmits the encryption key to the authentication processing section 102. Then, the authentication processing section 102 sets the encryption key for the communication processing unit 15 (sign S11). Thus, the communication processing unit 15 encrypts a downstream frame Fd using the encryption key. Then, the authentication processing section 102 controls turning on of the LED of the ONU 2 (sign S12). In this way, the normal authentication process is executed.

As described above, in the normal authentication process, many setting processes are performed. Thus, when re-establishment due to OLT factor is performed, the authentication processing section 102 omits some of the setting processes for an LL selected by a determination process to be described and thereby quickly resumes communication.

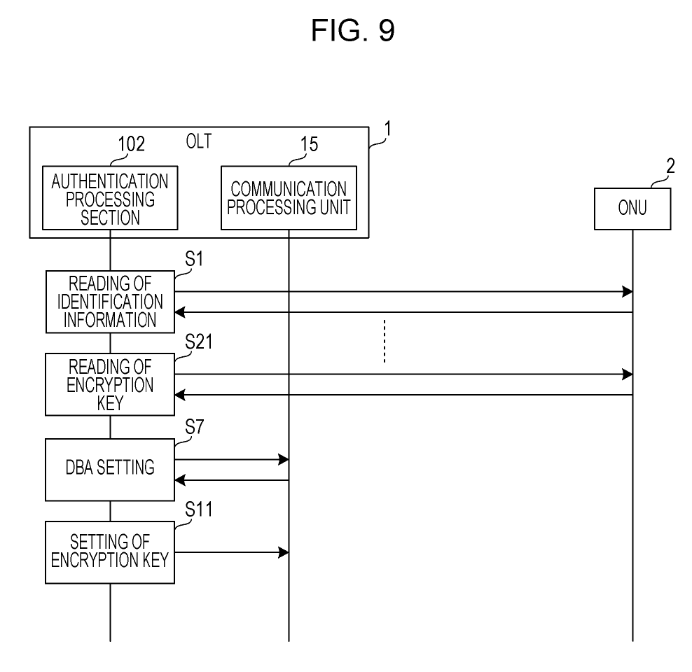

FIG. 9 is a sequence diagram illustrating an example of the simple authentication process. In FIG. 9, processes common to FIGS. 7 and 8 are denoted by the same signs, and descriptions thereof are omitted.

The authentication processing section 102 reads identification information (ONU-ID, MAC address) from the ONU 2 (sign S1). Then, the authentication processing section 102 reads an encryption key from the ONU 2 (sign S21). Then, the authentication processing section 102 performs DBA setting for the communication processing unit 15 (sign S7). DBA setting is performed based on, for example, HW setting information stored in the ONU management DB 330.

As just described, when re-establishment due to OLT factor is performed, for an LL for which setting immediately before the re-establishment has been completed, the authentication processing section 102 performs only enough setting to resume communication immediately before the re-establishment for the ONU 2 and the communication processing unit 15. For example, if the number of LLs is four, the number of accesses from the OLT 1 to the ONU 2 is, for example, 62 times in the normal authentication process, whereas the number of accesses is reduced to 5 times in the simple authentication process.

Furthermore, the authentication processing section 102 manages an LL state for each LL and periodically stores the LL state in the ONU management DB 330.

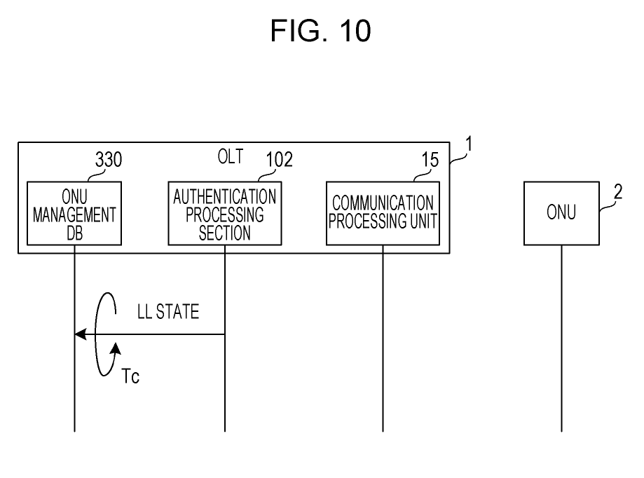

FIG. 10 is a sequence diagram illustrating an example of a process of acquiring an LL state. The authentication processing section 102 manages an LL state based on the above-described state transitions and stores the LL state in the ONU management DB 330 in a certain cycle Tc. An LL whose LL state is the authentication state is in a state in which communication is possible, and thus the authentication processing section 102 is able to more accurately determine, from the fact that the LL state is the authentication state in addition to a timing of re-establishment of the LL after disconnection, that re-establishment due to OLT factor has been performed.

Furthermore, after the normal authentication process, the authentication processing section 102 acquires specific information and an encryption key for each LL from the ONU 2 and stores the specific information and the encryption key in the ONU management DB 330.

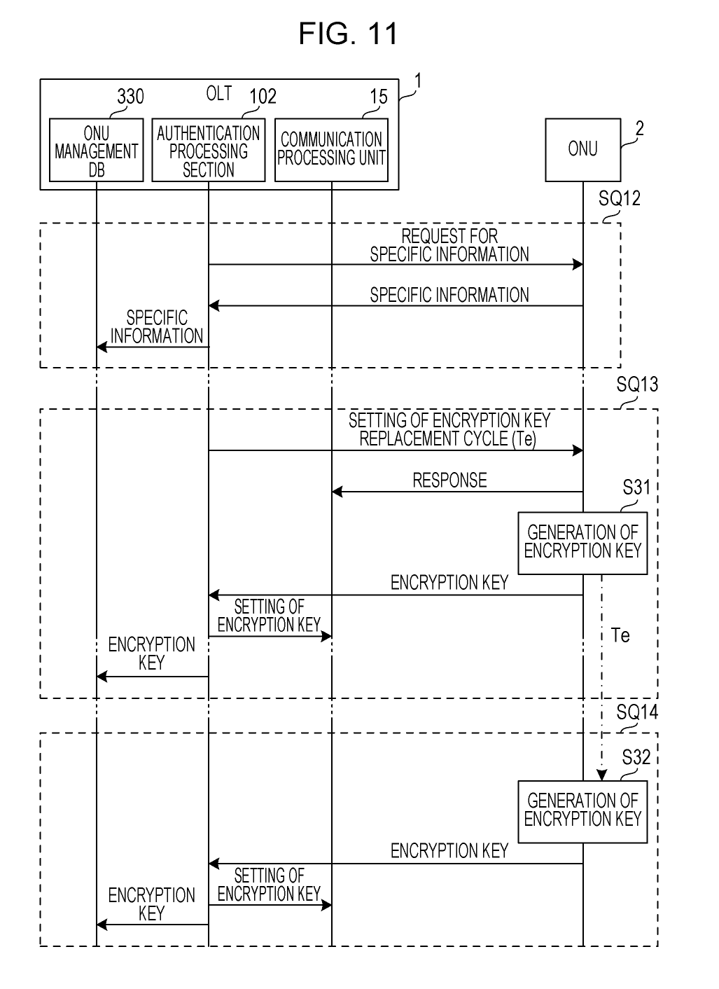

FIG. 11 is a sequence diagram illustrating an example of processes of acquiring specific information and an encryption key. The authentication processing section 102 executes a specific information acquisition sequence SQ12 after the normal authentication process. In the specific information acquisition sequence SQ12, the authentication processing section 102 makes a request to the ONU 2 for specific information of each LL by transmitting, for example, an OAM frame to the ONU 2. In response to the request, the ONU 2 transmits specific information to the OLT 1 using, for example, an OAM frame. The authentication processing section 102 stores the specific information in the ONU management DB 330.

Furthermore, the authentication processing section 102 executes an encryption key acquisition sequence SQ13 in the normal authentication process. The encryption key acquisition sequence SQ13 corresponds to the processes of signs S10 and S11 in FIG. 8.

The authentication processing section 102 sets a cycle in which an encryption key is replaced (encryption key replacement cycle) Te for the ONU 2. The ONU 2 transmits a response to the OLT 1 in response to the setting of the encryption key replacement cycle Te.

Then, the ONU 2 generates an encryption key (sign S31) and notifies the OLT 1 of the encryption key. The authentication processing section 102 sets the encryption key for the communication processing unit 15. Thus, the communication processing unit 15 starts encryption of a downstream frame Fd with the encryption key. An example of an encryption technique is the advanced encryption standard (AES), and the encryption technique is not limited to this. Then, the authentication processing section 102 stores the encryption key in the ONU management DB 330.

The authentication processing section 102 acquires an encryption key in an encryption key replacement sequence SQ14 performed in the encryption key replacement cycle Te after the normal authentication process. In the encryption key replacement sequence SQ14, the ONU 2 generates a new encryption key (sign S32) and transmits the new encryption key to the OLT 1. The authentication processing section 102 sets the encryption key for the communication processing unit 15 and then stores the encryption key in the ONU management DB 330. In this way, specific information and an encryption key are stored in the ONU management DB 330.

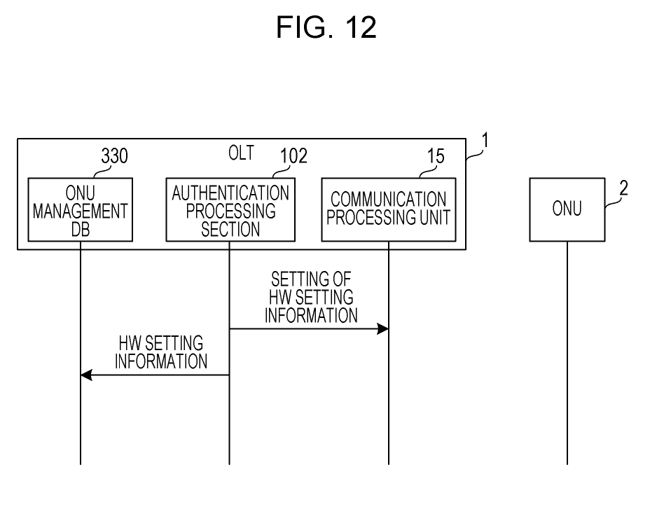

FIG. 12 is a sequence diagram illustrating an example of a process of storing HW setting information. HW setting information is set for the communication processing unit 15 not only in the authentication sequence SQ3 but also according to changes made to communication settings by the user, for example. Thus, the authentication processing section 102 sets HW setting information for the communication processing unit 15 at a certain timing. The authentication processing section 102 stores the HW setting information in the ONU management DB 330. The HW setting information stored in the ONU management DB 330 is used in the simple authentication process to reconstruct a communication state immediately before re-establishment due to OLT factor.

When the authentication processing section 102 determines that re-establishment due to OLT factor has been performed, the authentication processing section 102 acquires new specific information and a new encryption key from the ONU 2 and compares the new specific information and the new encryption key with specific information and an encryption key that are stored in the ONU management DB 330. That is, in accordance with a timing at which an LL has been re-established after disconnection, the authentication processing section 102 acquires processing information relating to communication of the LL from the ONU 2 and compares the processing information with processing information stored in the ONU management DB 330. With this, the authentication processing section 102 determines whether to execute the simple authentication process.

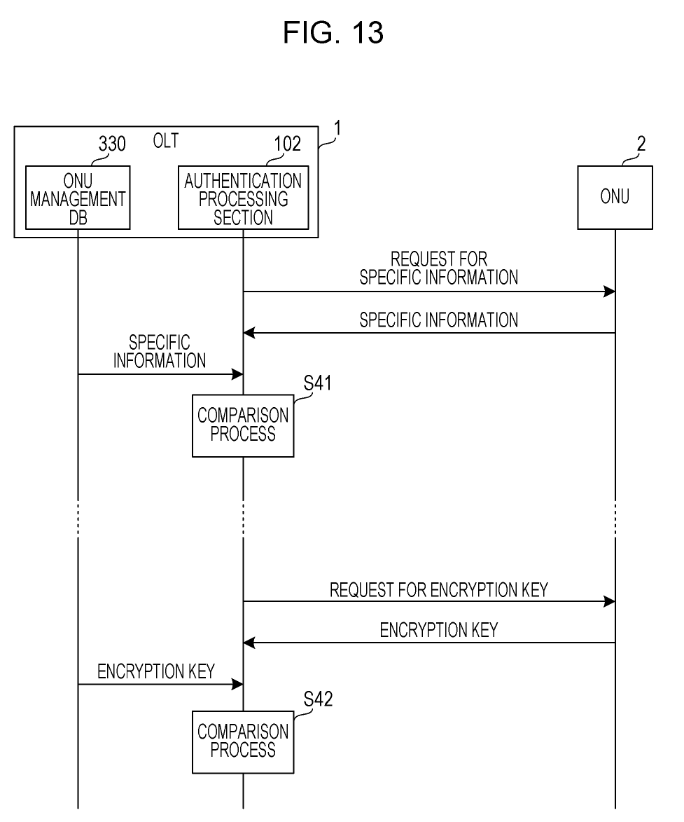

FIG. 13 is a sequence diagram illustrating an example of a determination process of determining whether to execute the simple authentication process. The authentication processing section 102 makes a request to the ONU 2 for specific information by transmitting an OAM frame. In response to the request, the ONU 2 transmits specific information to the OLT 1. When the authentication processing section 102 receives the specific information from the ONU 2, the authentication processing section 102 acquires specific information from the ONU management DB 330 and compares the pieces of specific information with each other (sign S41).

Then, the authentication processing section 102 makes a request to the ONU 2 for an encryption key by transmitting an OAM frame. In response to the request, the ONU 2 transmits an encryption key to the OLT 1. When the authentication processing section 102 receives the encryption key from the ONU 2, the authentication processing section 102 acquires an encryption key from the ONU management DB 330 and compares the encryption keys with each other (sign S42).

Both when the pieces of specific information coincide with each other and when the encryption keys coincide with each other, the authentication processing section 102 executes the simple authentication process.

As just described, in accordance with a result of comparing pieces of processing information relating to processing of communication, the authentication processing section 102 omits part of the authentication sequence SQ3 for an LL for which processing information acquired from the ONU 2 coincides with processing information stored in the ONU management DB 330. That is, the authentication processing section 102 executes the simple authentication process for an LL for which pieces of processing information coincide with each other, and executes the normal authentication process for an LL for which pieces of processing information do not coincide with each other.

The authentication processing section 102 is able to determine, by comparison of pieces of processing information with each other, whether latest communication setting has been performed for the ONU 2 immediately before re-establishment due to OLT factor, and thus is able to determine, for each LL, based on the determination, whether to execute the simple authentication process. For example, with respect to an ONU 2 having been restarted around the same time as re-establishment due to OLT factor, pieces of processing information of the ONU 2 do not coincide with each other, and thus it is determined that the simple authentication process is not able to be executed.

Here, the authentication processing section 102 uses a periodically updated encryption key as processing information and thus is able to accurately determine an LL for which the simple authentication process is able to be executed.

Hence, the authentication processing section 102 appropriately omits part of the authentication sequence SQ3 for an LL to reduce a time spent on the authentication sequence SQ3 and thus is able to quickly resume communication with the ONU 2.

Furthermore, when the authentication processing section 102 executes the simple authentication process, the authentication processing section 102 determines, from the statistical information TBL 130, normality of communication. For example, when both the number of transmission frames and the number of reception frames in the statistical information TBL 130 increase, the authentication processing section 102 determines that communication is normal. Otherwise, the authentication processing section 102 determines that communication is abnormal. If communication is abnormal, the authentication processing section 102 determines that LL communication setting has failed, and executes the normal authentication process.

As just described, when the authentication processing section 102 omits part of the authentication sequence SQ3 for an LL, the authentication processing section 102 determines, based on a communication amount of communication performed by the communication processing unit 15, normality of communication and executes the normal authentication process in accordance with a result of the determination. Thus, even if LL communication setting has failed, the authentication processing section 102 is able to perform LL communication setting again.

Next, operations performed by the line unit 80 will be described.

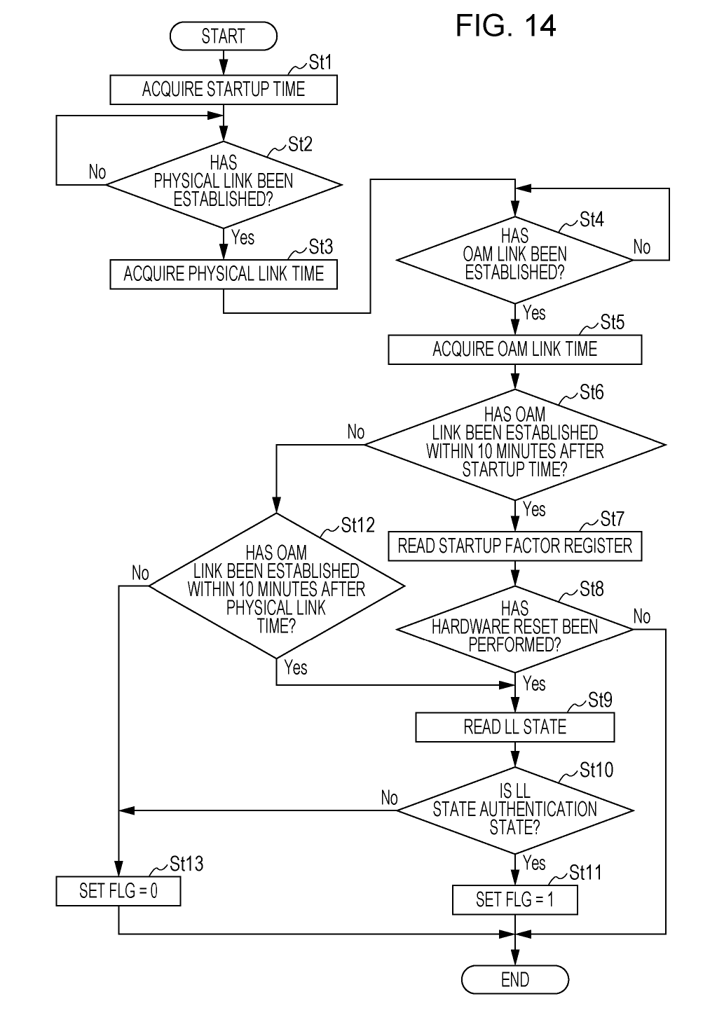

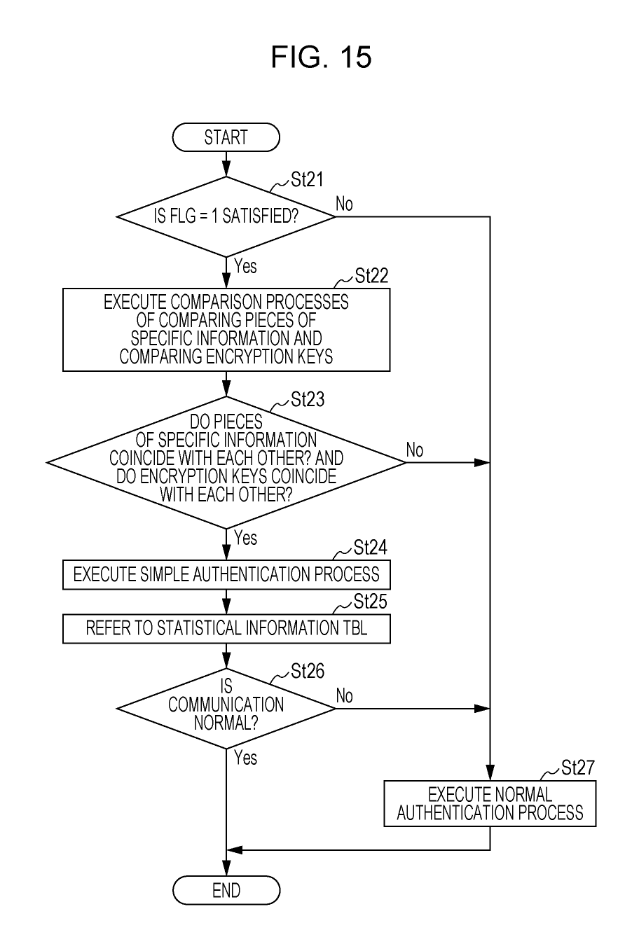

FIG. 14 is a flowchart illustrating an example of operations performed by the line unit 80 on startup. As described above, on startup, the line unit 80 executes a determination process of determining whether re-establishment due to OLT factor has been performed, and sets, in accordance with a result of the determination, a determination flag FLG indicating whether an LL is a candidate for the simple authentication process. Subsequently, the line unit 80 executes, in accordance with the determination flag FLG, comparison processes of comparing encryption keys and comparing pieces of specific information (see FIG. 15). Note that the following processes are executed for each LL.

When the line unit 80 is started up, the operation control section 100 acquires a startup time by using the clock section 100a (operation St1). Then, the port monitoring section 104 determines, based on a notification from the warning detection unit 151, whether a physical link has been established (operation St2). When no physical link has been established (No in operation St2), the port monitoring section 104 executes the process of operation St2 again.

When a physical link has been established (Yes in operation St2), the port monitoring section 104 acquires a physical link time from the clock section 100a (operation St3). Then, the link control section 105 executes the OAM discovery sequence SQ2 to thereby determine whether an OAM link has been established (operation St4). When no OAM link has been established (No in operation St4), the link control section 105 executes the process of operation St4 again.

When an OAM link has been established (Yes in operation St4), the link control section 105 acquires an OAM link time from the clock section 100a (operation St5). The operation control section 100 acquires the physical link time and the OAM link time and outputs the physical link time and the OAM link time together with the startup time to the authentication processing section 102. The link control section 105 may acquire a time of establishment of an LL in place of an OAM link time.

Then, the authentication processing section 102 determines, based on the startup time and the OAM link time, whether the OAM link has been established within 10 minutes after the startup of the line unit 80 (operation St6). More specifically, the authentication processing section 102 determines whether a time difference between the startup time and the OAM link time is 10 minutes or less.

As described above, in the case where there is a factor causing re-establishment of an LL on the OLT 1 side, the ONU 2 has already been started up, and thus a timing of re-establishment of the LL is earlier than that in the case where a factor causing re-establishment of the LL is an ONU 2-side factor (for example, a restart of the ONU 2). For this reason, when the OAM link has been established within 10 minutes after the startup of the line unit 80, there is a high possibility that re-establishment due to OLT factor may have been performed. Although, in this example, a time period from the startup to the establishment of the OAM link is set to 10 minutes as a determination criterion, the time period is not limited to this. A value of the time period may be another value.

When the OAM link has been established within 10 minutes after the startup of the line unit 80 (Yes in operation St6), the authentication processing section 102 reads a startup factor register from the startup factor holding unit 150 (operation St7). The authentication processing section 102 determines, from the startup factor register, whether a hardware reset of the line unit 80 has been performed (operation St8). When the authentication processing section 102 determines that a restart of the line unit 80 has been performed based on a software reset, that is, a restart of the program of the CPU 10 (No in operation St8), the authentication processing section 102 determines that the authentication sequence SQ3 for the ONU 2 does not have to be performed, and ends the process.

Furthermore, when the authentication processing section 102 determines that a hardware reset has been performed (Yes in operation St8), the authentication processing section 102 reads an LL state from the ONU management DB 330 (operation St9). Then, the authentication processing section 102 determines whether the LL state is the authentication state (operation St10). With this, the authentication processing section 102 more accurately determines that re-establishment due to OLT factor has been performed, and thus determines that the LL has been in the authentication state immediately before the re-establishment.

When the LL state is the authentication state (Yes in operation St10), the authentication processing section 102 sets the determination flag FLG to 1 to cause the LL to serve as a candidate for the simple authentication process (operation St11). Furthermore, when the LL state is not the authentication state (No in operation St10), the authentication processing section 102 sets the determination flag FLG to 0 to cause the LL to serve as a target for the normal authentication process (operation St13). Subsequently, the authentication processing section 102 ends the process.

Furthermore, when the OAM link has been established after 10 minutes have elapsed since the startup of the line unit 80 (No in operation St6), the authentication processing section 102 determines, based on the physical link time and the OAM link time, whether the OAM link has been established within 10 minutes after the establishment of the physical link (operation St12). More specifically, the authentication processing section 102 determines whether a time difference between the physical link time and the OAM link time is 10 minutes or less.

For the above-described reason, when the OAM link has been established within 10 minutes after the establishment of the physical link, there is a high possibility that re-establishment due to OLT factor may have been performed. Although, in this example, a time period from the establishment of the physical link to the establishment of the OAM link is set to 10 minutes as a determination criterion, the time period is not limited to this. A value of the time period may be another value.

When the OAM link has been established within 10 minutes after the establishment of the physical link (Yes in operation St12), the authentication processing section 102 executes the processes of operation St9 and subsequent operations described above. Thus, in this case, the determination flag FLG is set to 1.

Furthermore, when the OAM link has been established after 10 minutes have elapsed since the establishment of the physical link (No in operation St12), the authentication processing section 102 sets the determination flag FLG to 0 (operation St13). Subsequently, the authentication processing section 102 ends the process.

Next, the authentication processing section 102 executes the authentication sequence SQ3.

FIG. 15 is a flowchart illustrating an example of operations performed by the line unit 80 when the authentication sequence SQ3 is executed. The authentication processing section 102 determines whether the determination flag FLG is 1 (operation St21). When the determination flag FLG is 0 (No in operation St21), the authentication processing section 102 executes the normal authentication process (operation St27), and ends the process. At this time, the authentication processing section 102 changes the LL state from the non-authentication state to the authentication state.

Furthermore, when the determination flag FLG is 1 (Yes in operation St21), the authentication processing section 102 executes comparison processes of comparing pieces of specific information and comparing encryption keys (operation St22). The comparison processes of comparing pieces of specific information and comparing encryption keys have been described above with reference to FIG. 13.

Thus, the authentication processing section 102 acquires specific information and an encryption key of an LL from the ONU 2 in accordance with a time period that has elapsed from when the line unit 80 was started up to when the LL is re-established, and compares the specific information and the encryption key with specific information and an encryption key that are stored in the ONU management DB 330. Furthermore, the authentication processing section 102 acquires specific information and an encryption key of an LL from the ONU 2 in accordance with a time period that has elapsed from when the line unit 80 and the ONU 2 were connected via the optical fiber 90 to when the LL is re-established, and compares the specific information and the encryption key with specific information and an encryption key that are stored in the ONU management DB 330.

Thus, when the authentication processing section 102 determines, from a timing of re-establishment of an LL, that re-establishment due to OLT factor has been performed, the authentication processing section 102 compares pieces of specific information with each other, compares encryption keys with each other, and thus is able to select an LL that serves as a candidate for the simple authentication process.

Furthermore, the authentication processing section 102 acquires specific information and an encryption key of an LL from the ONU 2 in accordance with an LL state, and compares the specific information and the encryption key with specific information and an encryption key that are stored in the ONU management DB 330. Thus, when the authentication processing section 102 further determines, from an LL state, that re-establishment due to OLT factor has been performed, the authentication processing section 102 compares pieces of specific information with each other, compares encryption keys with each other, and thus is able to select an LL that serves as a candidate for the simple authentication process.

In other words, in accordance with a timing of re-establishment of an LL and an LL state, the authentication processing section 102 is able to remove, from candidates for the simple authentication, an LL of an ONU 2 having been restarted on startup of the line unit 80 or an LL of an ONU 2 having been newly added.

At least when the pieces of specific information do not coincide with each other, or at least when the encryption keys do not coincide with each other (No in operation St23), the authentication processing section 102 executes the normal authentication process (operation St27). At this time, the authentication processing section 102 changes the LL state from the non-authentication state to the authentication state.

Furthermore, both when the pieces of specific information coincide with each other and when the encryption keys coincide with each other (Yes in operation St23), the authentication processing section 102 executes the simple authentication process (operation St24). At this time, the authentication processing section 102 changes the LL state from the non-authentication state to the temporary authentication state.

Then, the authentication processing section 102 refers to the statistical information TBL 130 (operation St25). Then, the authentication processing section 102 determines, from the statistical information TBL 130, normality of communication (operation St26). When communication is normal (Yes in operation St26), the authentication processing section 102 changes the LL state to the authentication state, and ends the process.

Furthermore, when communication is abnormal (No in operation St26), the authentication processing section 102 executes the normal authentication process (operation St27), changes the LL state to the authentication state, and ends the process. Note that operations illustrated in FIGS. 14 and 15 are an example of a communication method.

As just described, when the authentication processing section 102 executes the simple authentication process, the authentication processing section 102 determines, based on a communication amount of communication performed by the communication processing unit 15, normality of communication and executes the normal authentication process in accordance with a result of the determination. Thus, even if LL communication setting has failed, the authentication processing section 102 is able to perform LL communication setting again.

As described above, the authentication processing section 102 executes the simple authentication process for an LL to thereby reduce a time spent on the authentication sequence SQ3.

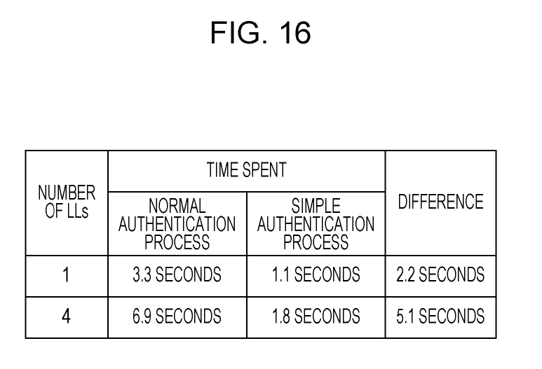

FIG. 16 illustrates an example of times spent on the normal authentication process and the simple authentication process for each of the numbers of LLs. In this example, a time spent on the normal authentication process illustrated in FIGS. 7 and 8 and a time spent on the simple authentication process illustrated in FIG. 9 are illustrated.

Although a difference between times spent on the normal authentication process and the simple authentication process is 2.2 seconds when the number of LLs is 1, the difference is 5.1 seconds when the number of LLs is 4. Thus, as the number of LLs increases, a time spent on the authentication sequence SQ3 decreases.

The above-described embodiment is an exemplary embodiment. Note that the disclosed technique is not limited to this, and various modifications may be made within the scope of the gist of the embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A transmission apparatus comprising:
a memory; and
a processor coupled to the memory and the processor configured to:
process communication performed via logical links established between the transmission apparatus and a plurality of optical network units (ONUs) coupled to branch ends of a transmission line; and
perform, for each of the logical links, a setting process for the communication for the plurality of ONUs,
the processor being further configured to
acquire, after the setting process, pieces of processing information relating to processing of the communication from the plurality of ONUs for each of the logical links, and store the pieces of processing information in a database,
acquire, in accordance with timings at which the logical links have been re-established after disconnection, pieces of processing information of the logical links from the plurality of ONUs, and make a comparison of the pieces of processing information with the pieces of processing information stored in the database, and
omit, in accordance with a result of the comparison, part of the setting process for the logical links for which the pieces of processing information acquired from the plurality of ONUs coincide with the pieces of processing information stored in the database.

2. The transmission apparatus according to claim 1,
wherein the processor acquires, in accordance with time periods that have elapsed from when the transmission apparatus was started up to when the logical links are re-established, pieces of processing information of the logical links from the plurality of ONUs, and makes a comparison of the pieces of processing information with the pieces of processing information stored in the database.

3. The transmission apparatus according to claim 1,
wherein the processor acquires, in accordance with time periods that have elapsed from when the transmission apparatus and the plurality of ONUs were connected via the transmission line to when the logical links are re-established, pieces of processing information of the logical links from the plurality of ONUs, and makes a comparison of the pieces of processing information with the pieces of processing information stored in the database.

4. The transmission apparatus according to claim 1,
wherein the processor
stores pieces of state information relating to states of the setting process of the respective logical links in the database, and
acquires, in accordance with the pieces of state information of the respective logical links, pieces of processing information of the logical links from the plurality of ONUs, and makes a comparison of the pieces of processing information with the pieces of processing information stored in the database.

5. The transmission apparatus according to claim 1, the processor is further configured to:
detect communication amounts of the communication for the respective logical links,
wherein, when the processor omits part of the setting process for the logical links, the memory and processor makes, based on each of the communication amounts of the communication, a determination of whether the communication is normal, and performs the setting process in accordance with a result of the determination.

6. The transmission apparatus according to claim 1,
wherein the pieces of processing information include an encryption key that is periodically updated and is used for encryption of the communication.

7. A communication method comprising:
processing communication performed via logical links established between the transmission apparatus and a plurality of optical network units (ONUs) coupled to branch ends of a transmission line;
performing, for each of the logical links, a setting process for the communication for the plurality of ONUs, by a processor,
wherein the processor
acquires, after the setting process, pieces of processing information relating to processing of the communication from the plurality of ONUs for each of the logical links, and stores the pieces of processing information in a database,
acquires, in accordance with timings at which the logical links have been re-established after disconnection, pieces of processing information of the logical links from the plurality of ONUs, and makes a comparison of the pieces of processing information with the pieces of processing information stored in the database, and
omits, in accordance with a result of the comparison, part of the setting process for the logical links for which the pieces of processing information acquired from the plurality of ONUs coincide with the pieces of processing information stored in the database.

8. The communication method according to claim 7,
wherein the processor acquires, in accordance with time periods that have elapsed from when the transmission apparatus was started up to when the logical links are re-established, pieces of processing information of the logical links from the plurality of ONUs, and makes a comparison of the pieces of processing information with the pieces of processing information stored in the database.

9. The communication method according to claim 7,
wherein the processor acquires, in accordance with time periods that have elapsed from when the transmission apparatus and the plurality of ONUs were connected via the transmission line to when the logical links are re-established, pieces of processing information of the logical links from the plurality of ONUs, and makes a comparison of the pieces of processing information with the pieces of processing information stored in the database.

10. The communication method according to claim 7,
wherein the processor
stores pieces of state information relating to states of the setting process of the respective logical links in the database, and
acquires, in accordance with the pieces of state information of the respective logical links, pieces of processing information of the logical links from the plurality of ONUs, and makes a comparison of the pieces of processing information with the pieces of processing information stored in the database.

11. The communication method according to claim 7, further comprising:
detecting communication amounts of the communication for the respective logical links, by the processor,
wherein, when the processor omits part of the setting process for the logical links, the memory and processor makes, based on each of the communication amounts of the communication, a determination of whether the communication is normal, and performs the setting process in accordance with a result of the determination.

12. The communication apparatus according to claim 7,
wherein the pieces of processing information include an encryption key that is periodically updated and is used for encryption of the communication.

13. A communication method comprising:
processing communication performed via logical links established between a transmission apparatus and an optical network unit (ONU) coupled via a transmission line; and
performing, for each of the logical links, a setting process for communication for the ONU by a processor,
the processor,
acquires first processing information from the ONU,
acquires second processing information stored in a database,
compares the first processing information and the second processing information,
acquires a first encryption key from the ONU,
acquires a second encryption key stored in the database,
compares the first encryption key and the second encryption key, and
when the first processing information coincides with the second processing information and when the first encryption key coincides with the second encryption key, omits parts of the setting process to decrease a time of an authentication process for the communication between the transmission apparatus and the optical network unit.
